(19) United States
(12) Patent Application Publication
(10) Pub. No.: US 2014/0288998 A1
(43) Pub. Date: Sep. 25, 2014

(54) System and method for obtaining and paying for consumer data

(71) Applicant: Paul E. Paray, Hohokus, NJ (US)

(72) Inventor: Paul E. Paray, Hohokus, NJ (US)

(21) Appl. No.: 13/986,013

(22) Filed: Mar. 22, 2013

(51) Int. Cl. G06Q 20/22; G06Q 40/00; G06Q 30/02

(52) U.S. Cl. CPC G06Q 20/29; G06Q 30/0201; G06Q 40/10
USPC 705/7.29

(57) ABSTRACT

Consumer data is securely obtained and offered to merchants or their agents in return for monetary compensation. The data's financial worth depends on whether a consumer provides anonymous, personally identifiable information, geo-tracking data, or mobile payment tracking data. The micropayments can be agreed upon in advance, bid on, or a combination of both. A necessary characteristic of the system is the safe and efficient flow of privacy data in return for micropayments that are securely made to consumers and able to be aggregated.

### BACKGROUND OF THE INVENTION

According to the World Economic Forum, “personal data represents an emerging asset class, potentially every bit as valuable as other assets such as traded goods, gold or oil.” Rethinking Personal Data: Strengthening Trust, at 7, World Economic Forum Report (May 2012). There are certain privacy rights that underlie this “emerging asset class”: “(1) Unobservability is when you cannot be observed. For example, shutting the door to the bathroom offers unobservability; (2) To Be Left Alone . . . ; (3) Untracability is when you cannot be traced from one identity to another. For example, “John, who we play softball with, but don't know his last name” is untraceable; you can't track down a phone number for him; (4) Informational self-determination is when you are confident that information you provide will be used only in ways you understand and approve. Giving your mother a new phone number probably qualifies; and (5) Anonymity is when you are without any identifiers.” People Won't Pay For Privacy, Reconsidered presented by Adam Shostack at the 2nd Annual Workshop on Economics and Information Security, College Park, Md., May 2003, at 2 (emphasis in original). See also Gavison, Ruth, Privacy and the Limits of Law, 89 The Yale Law Journal 421, 428-429 (1980) (“A loss of privacy occurs as others obtain information about an individual, pay attention to him, or gain access to him. These three elements of secrecy, anonymity, and solitude are distinct and independent, but interrelated, and the complex concept of privacy is richer than any definition centered around only one of them.”).

Current online behavioral advertising (OBA)¹ has made it so these privacy rights may not be easily managed during online activities—it is not generally up to consumers whether they will be fed an ad based on previous website visits or purchases—it will just happen. Indeed, according to a survey of 1,000 persons conducted by Ipsos Public Affairs and released by Microsoft in January 2013, forty-five percent of respondents felt they had little or no control over the personal information companies gather about them while they are browsing the Web or using online services. This view may not be unfounded given that data routinely gathered online, e.g., operating system, browser, IP address, persistent cookies, last used server, can be used to divulge the activity of individual devices. ¹According to the Interactive Advertizing Bureau (IAB), which is comprised of more than “500 leading media and technology companies that are responsible for selling 86% of online advertising” in the United States, “[o]nline behavioral advertising—sometimes called “interest-based advertising”—is the practice of collecting data from a particular computer or device regarding Internet-viewing behavior over time and across non-affiliate websites for the purpose of inferring user preferences or interests to later deliver advertising to that computer or device based on those inferred preferences or interests.”

Consumers who try to “shut off” or render anonymous access to their device's data or settings, would not only likely fail in their attempt at being anonymized, they would also lose out on fast and efficient searches with online search engines, access to most social media and other websites requiring browsers to accept cookies, and product offers that may presumably are of interest. Moreover, this coordinated tracking of consumers is not even unique to the Internet. See generally Bibas, Steve, A Contractual Approach to Data Privacy, 17 Harv, I. Law & Public Policy 591 (Spring 1994) (“Although the ready availability of information helps us to trust others and coordinate actions, it also lessens our privacy. George Orwell presciently expressed our fear of losing all privacy to an omniscient Big Brother. Computers today track our telephone calls, credit-card spending, plane flights, educational and employment records, medical histories, and more. Someone with free access to this information could piece together a coherent picture of our actions.”). Indeed, there are companies that can bridge the gap between offline and online activities by taking in-store point of sale purchases and converting such data to an anonymous online cookie ID that will eventually be used online by clients—all the while without ever informing the consumer of this conversion. Such use of in-store data is generally permissible under a retailer's “loyalty program”.

Current law does not prevent someone from collecting public information to create consumer profiles—nor is there the right to opt out of having your public record information sold or shared. And, when one wants to self-determine whether personally identifiable information (PII) will be disclosed or whether he or she will be “left alone”, “untraceable”, or “anonymous”, there may not always exist the ability to easily protect these rights and there is certainly no way to obtain a direct financial gain in return for the relinquishment of such privacy rights. Instead, there has generally been a “privacy for services” marketing/advertizing arrangement that has been accepted by consumers—which, in fact, has helped pay for and fuel the growth of the commercial Internet. It should come as no surprise that the TAB was founded in 1996—during the very infancy of the commercial Internet.

The current OBA ecosystem does not posit a “loss of privacy” as much as it offers a bartering system where one party feels the value of what is being bartered away while the other party actually quantifies with cascading/monetizing transactions what is only felt by the other party. In other words, it is not a financial transaction. Those who are able to find an entertaining online video or locate a product online using a search engine don't really mind that an ad will be served to them while visiting some other website given they feel this loss of privacy is worth the value of the services being provided. This privacy-cum-currency feedback loop is not accomplished with money changing hands.

Ironically, the interactive advertising industry itself believes it is collecting too much sensitive consumer data. According to a study conducted by the Ponemon Institute, 67 percent of responding online advertisers believe “limiting sensitive data collection for OBA purposes is key to improving consumer privacy and control when browsing or shopping online.” Leading Practices in Behavioral Advertising & Consumer Privacy: A Study of Internet Marketers & Advertisers, at 2, The Ponemon Institute (February 2012).

It is anticipated that a true cash compensation scheme would alter the current privacy landscape to one where consumers have more of a say in how their personal data is used. Moreover, once there is some way to correlate consumer data to a monetary amount, the same protections afforded other currencies will be more amendable to such data. Unfortunately, there is no way to predict the success of such a system with any level of certitude. As recognized by privacy researchers, “[e]mpirical evidence on the behavioral effects of privacy is rather scarce.” Regner, Tobias; Riener, Gerhard, Voluntary Payments, Privacy and Social Pressure On The Internet: A Natural Field Experiment, DICE Discussion Paper, No. 82 (December 2012) at 6. Although “some consumers are willing to pay a premium to purchase from privacy protective websites”; there is no measure of what that premium should be or how widespread a factor it is for consumers as a whole. Id. at 7.

More often than not, consumers have been “often willing to provide personal information for small or no rewards.” Losses, Gains, and Hyperbolic Discounting: An Experimental Approach to Information Security Attitudes and Behavior, presented by Alessandro Acquisti and Jens Grossklags at the 2nd Annual Workshop on Economics and Information Security, College Park, Md., May 2003, at 4.

This does not mean researchers have not tried to quantify a “privacy compensation” model. In 2002, a Jupiter Research study found 82% of online shoppers willing to give personal data to new shopping sites in exchange for the chance to win $100. See c.f. Tsai, Janice; Egelman, Serge; Cranor, Louie; Acquisti, Alessandro; The Effect of Online Privacy Information on Purchasing Behavior: An Experimental Study, Information Systems Research (February 2010) at 22 (describing survey results which concludes that “people will tend to purchase from merchants that offer more privacy protection and even pay a premium to purchase from such merchants.”); Beresford, Alastair; Küibler, Dorothea; Preibusch, Sören, Unwillingness To Pay For Privacy: A Field Experiment, 117 Economics Letters 25 (2010) (“Thus, participants predominantly chose the firm with the lower price and the more sensitive data requirement, indicating that they are willing to provide information about their monthly income and date of birth for a 1 Euro discount.”).

In his 1994 paper, A Contractual Approach to Data Privacy, Steve Bibas suggests that individual contracts may provide the best solution to the privacy compensation dilemma: “In the hands of the contracting parties, however, flexibility allows people to control their lives and efficiently tailor the law to meet their needs. Flexibility is the market's forte; the pricing mechanism is extremely sensitive to variations in valuation and quickly adjusts to them.” Bibas, 17 Harv. J. Law & Public Policy 591 (Spring 1994). He gives the following hypothetical:

The Book-of-the-Month Club has ten customers, C1 through C10, most of whom loathe telephone solicitations but do not care as much about junk mail . . . If the Book Club offers the choices: no privacy plus five dollars, or complete privacy, eight of the ten consumers will contract for privacy because the privacy is worth more than five dollars to them. The Book Club will pay each of the remaining two consumers five dollars for their addresses and telephone numbers, sell these data for nine dollars per person, and make an eight dollar profit.

The Book Club, however, can make more money if it unilaterally promises not to disclose anyone's telephone number. If it offers the options: telephone-number privacy plus five dollars, or complete privacy, then only two privacy lovers will contract for complete privacy. The other eight consumers will choose not to opt out. The Book Club, therefore, will pay each of these eight consumers five dollars, sell their addresses for seven dollars, and make a sixteen dollar profit.

Mr. Bibas, however, recognized the limitations in what could be accomplished with privacy transactions that relied only on static privacy trades: “The Book Club could, in theory, achieve the same result by offering consumers an option for telephone-number privacy as well as a total-privacy option. But the additional costs of drafting and handling new forms would probably make this option impractical.” Id. at fn 113 (emphasis added). In other words, the only model that might be effective is one that customizes the financial rewards paid to consumers based on a continuous exchange of information between the consumer and the merchant/agent.

One reason there is currently no viable solution to the consumer privacy problem most consumers face is the fact all other marketed solutions fail to also create an acceptable solution for merchants. Merchants would certainly benefit from a “more direct” route to consumers given digital footprints are always subject to compromise from botnets used to inflate page view counts and give the impression that consumers had actually visited certain websites when they had not. And, those recently formed companies promising a private web experience will not be able to—nor should they even try—to curtail firms from using OBA to reach consumers.

There are other new services looking to solve the consumer privacy problem. On Jun. 13, 2012, Ten Ball Labs, LLC announced a new service called “Ten Quick Questions” where “consumers are paid a cash royalty every time they click on an advertisement delivered to them via the use of their opt-in data.” Unlike the subject system, such a model runs on the static privacy trade of consumer data, i.e., “ten quick questions”, that is inherently inferior to one where information and money is traded back and forth. Moreover, the Ten Quick Questions system requires the consumer to search out for offers by surfing online and limits the sort of data response subject to compensation to that of a standard click through.

Another system has claimed an expansion of loyalty reward programs that allows for the aggregation of data and expanded usability of rewards for purchases. In U.S. patent application Ser. No. 13/567,348 (“System For An Integrated Multi-Vendor Customer Loyalty And Targeted Marketing Program And Method For Its Use”), published on Feb. 7, 2013, there is claimed a system “wherein consumers receive credits for sales transactions according to operating parameters of a plurality of vendors' loyalty programs, and the credits are recorded in individual consumer vendor-specific subaccounts.” Unlike the present system, however, that method involves rewards/credits and does not involve cash payments.

More importantly, it runs counter to the present system's desire to curtail the unknown use of consumer data given it “involves the creation of a single, centralized consumer account to which the system automatically allocates and applies credits to individual vendor-specific subaccounts by dividing and segregating the credits for any given sales transaction.” This is antithetical to the subject system given it does not limit the disclosure of a consumer's data to only those merchants or agents who are willing to pay a specific price for the data. Indeed, the “Multi-Vendor Customer Loyalty” Program subject to U.S. patent application Ser. No. 13/567,348 suggests that its system “allows for significantly rich data mining capabilities.”

There is no present model which offers consumers and merchants the unique capability to financially reward the consumer for specific consumer data while maintaining the privacy choices of the consumer and immediately quantifying the financial value of the data for all parties.

Although companies such as GoldenPalace.com have paid thousands of dollars for people to advertize their products and services using permanent tattoos, marketing firms may pay out millions each year to consumers for their opinions on a range of topics, and retailers provide reward points which morph to cash credits for shoppers who allow the retailer to track purchases via loyalty programs, no current system offers actual individualized cash payments for the privacy losses potentially sustained each day by millions of consumers.

### BRIEF SUMMARY

The preferred embodiment of the present invention relates to a method and system for providing consumers with an efficient, secure, and financially attractive means of monetizing privacy rights. The preferred embodiment allows a consumer to provide personal information on an incremental basis in return for micro-payments which are aggregated and deposited in the consumer's account.

The system which is the subject of the invention removes the barriers faced by consumers looking to achieve a fast and direct financial return for the relinquishment of privacy rights. Typically, returns are not financial in nature and take time to mature into some sort of reward for the consumer. Online surfers who take advantage of services found on social media websites readily part with unknown aspects of their privacy in return for the use of such services. Most times, users do not fully appreciate or know exactly how the relinquished information or their online activities will be used by third parties to provide offers which may actually be of interest.

One cornerstone of the preferred embodiment is the efficient and secure means in which the micropayment system is structured and incentives provided. Although direct compensation schemes used to entice new clients are not new, e.g., providing potential automobile buyers with a $100 gift card to test drive a car, there is no automated system for exchanging incremental privacy rights in return for monetary compensation.

The preferred embodiments dictate that only applicants meeting certain criteria can participate in the system. Moreover, in one embodiment, applicants can, for example, choose to only provide broad personal data that will allow limited privacy disclosures—as well as limited opportunities to generate income. The preferred embodiments require a high level of disclosure in order to generate maximum revenue opportunities.

An object of at least one of the preferred embodiments is a system that facilitates the creation of a comprehensive database of industry-specific PII questions that are tied to monetary amounts with the ultimate goal of correlating certain privacy rights with set monetary amounts.

Another object of at least one of the preferred embodiments is to streamline the process of obtaining likely purchasers by paying for them to disclose their likely upcoming purchase decisions.

Another object of at least one of the preferred embodiments is to streamline the sales cycle process by ensuring merchants have ready buyers.

Another object of at least one of the preferred embodiments is to improve upon the data gathering of merchants by providing consumers with monetary compensation in return for providing geo-tracking and mobile payment data.

### DESCRIPTION OF THE FIGURES

The figures illustrate one embodiment contemplated for carrying out the present invention.

FIG. 1 illustrates the application process for gaining access to the system, in accordance with one embodiment of the present invention.

FIG. 2 illustrates the application review and security process of the system, in accordance with one embodiment of the present invention.

FIG. 3 illustrates the bidding process under the system, in accordance with one embodiment of the present invention.

FIG. 4 illustrates the geo-tracking process under the system, in accordance with one embodiment of the present invention.

FIG. 5 illustrates the mobile payment tracking process wider the system, in accordance with one embodiment of the present invention.

FIG. 6 illustrates the payment process under the system, in accordance with one embodiment of the present invention.

### DETAILED DESCRIPTION OF THE PREFERRED EMBODIMENTS

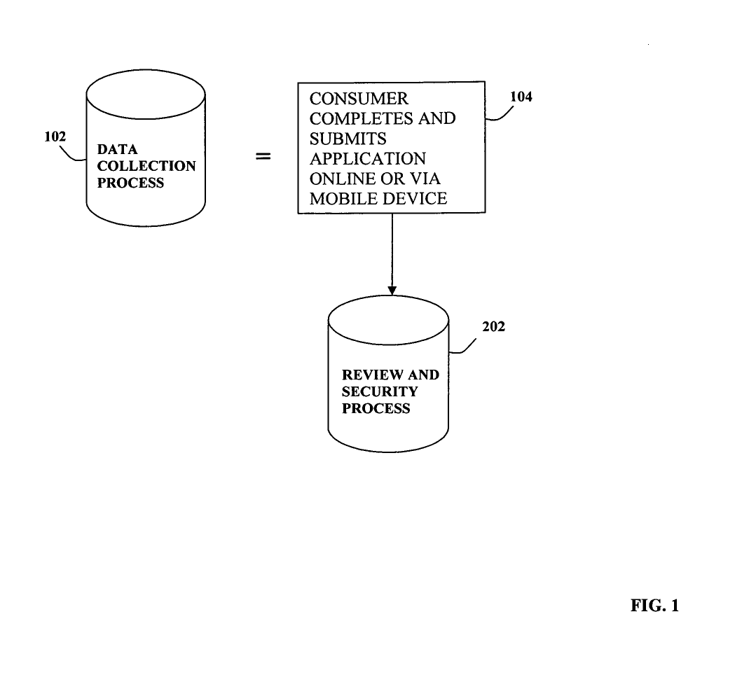

The following detailed description, which is described with reference to FIGS. 1-6, is given by way of example and is not intended to limit the embodiments of the present invention. For example, one embodiment of the present invention may only focus on the collection of geo-tracking and mobile payment data in return for monetary compensation.

FIG. 1 depicts the primary step of the system, namely the application process 102. The first step in the application process 104 requires that an applicant/consumer complete an application obtained online or via a mobile device app. Merchants and agents (who are working on behalf of merchants) have already committed to providing pricing terms that are guaranteed based on certain answers to the application. After submission, the review and security process is initiated 202 whereby the application's data is tokenized to ensure all PII is properly segregated and adequately secured. 204 The data may be rejected outright due to repudiation of the consumer's identity or inability to satisfy threshold financial criteria 208. If feasible, the consumer will be afforded an opportunity to correct the deficiencies 210 and the new application will either be accepted or rejected 212.

If the application is accepted, initial payments (based on responses to the initial application), product or service offers (some preset and others derived from a bidding process to merchants and agents) are made to the consumer 206. In one embodiment of the present invention the consumer is given various options to provide more data in return for additional micropayments being sent to the consumer's financial account. The consumer has opportunities to increase these payments by providing more information requested in an offer or actually satisfying the terms of a particular offer. Upon meeting such requirements, the payment process 502, or bidding process 302 is initialed, or a combination of both.

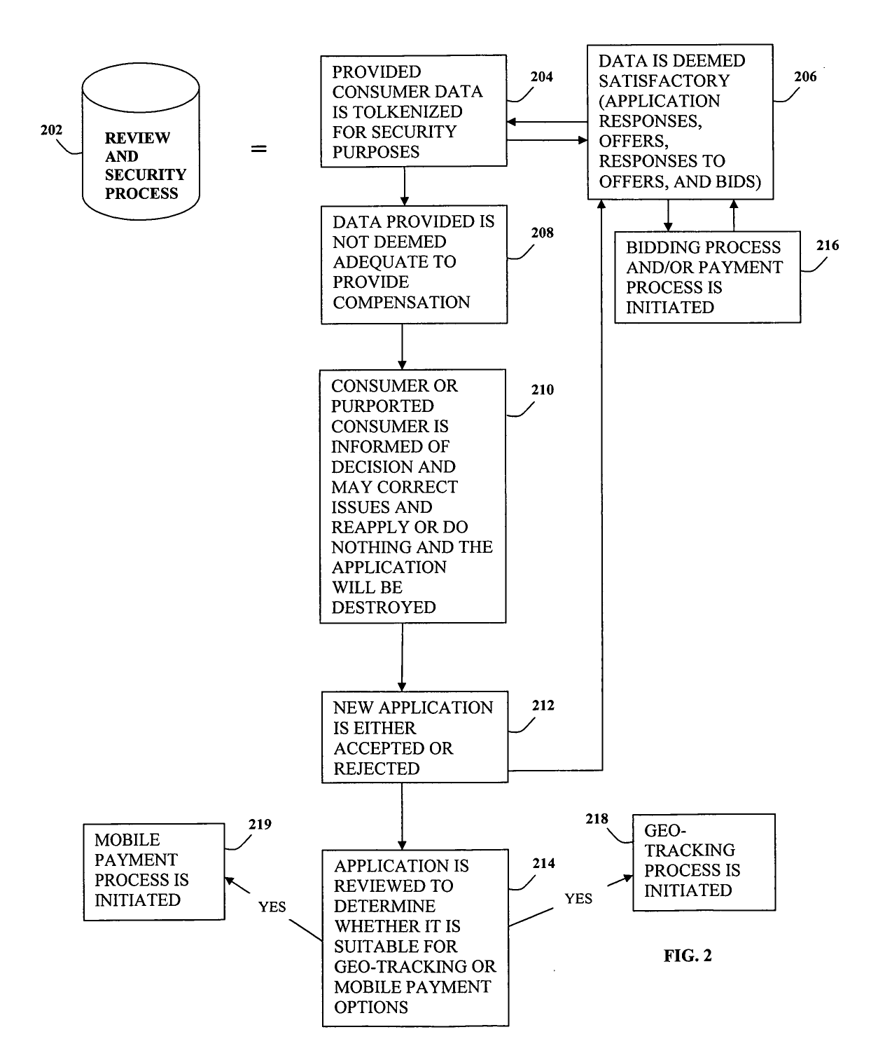

As illustrated in FIG. 2, the consumer is provided with an opportunity for generating further revenue by allowing for cash compensation in return for the geo-tracking data of the consumer 214 whereby a geo-tracking process may be initiated 218 or mobile payment tracking process may be initiated 219.

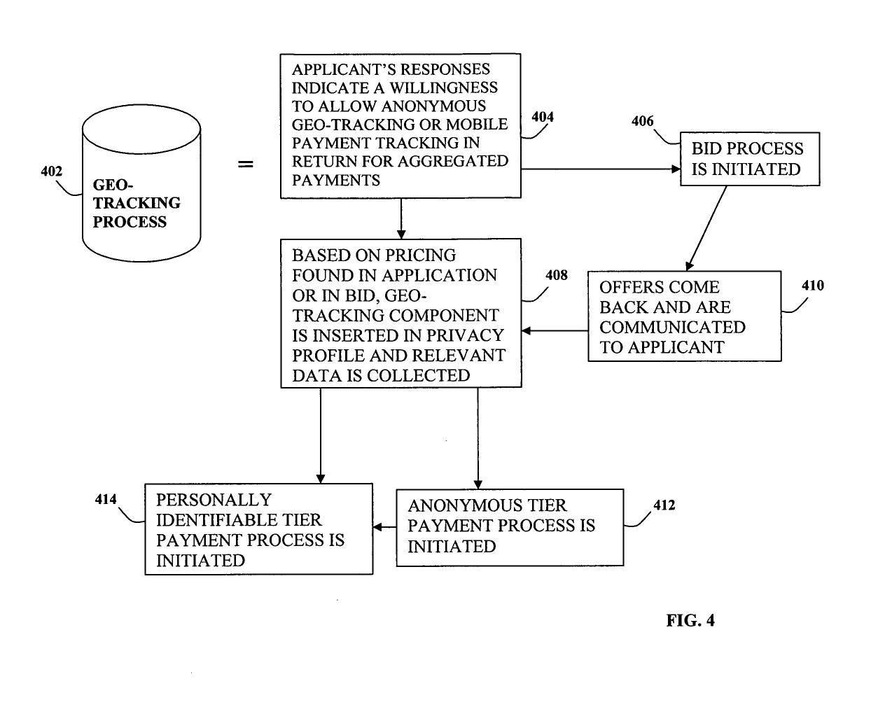

The geo-tracking process 402 illustrated within FIG. 4 first requires that the applicant indicate a willingness to allow for geo-tracking and mobile payment tracking in return for cash compensation 404. The pricing will be pre-determined 408 or will initiate the bid process 406. After the offers are communicated to the consumer 410 they become part of the consumer's privacy profile 408 and if complied with will allow for payment based on anonymous data being made available 412 or actual PII being provided 414. Consumers can always increase payments by changing privacy tier levels from anonymous to PII status.

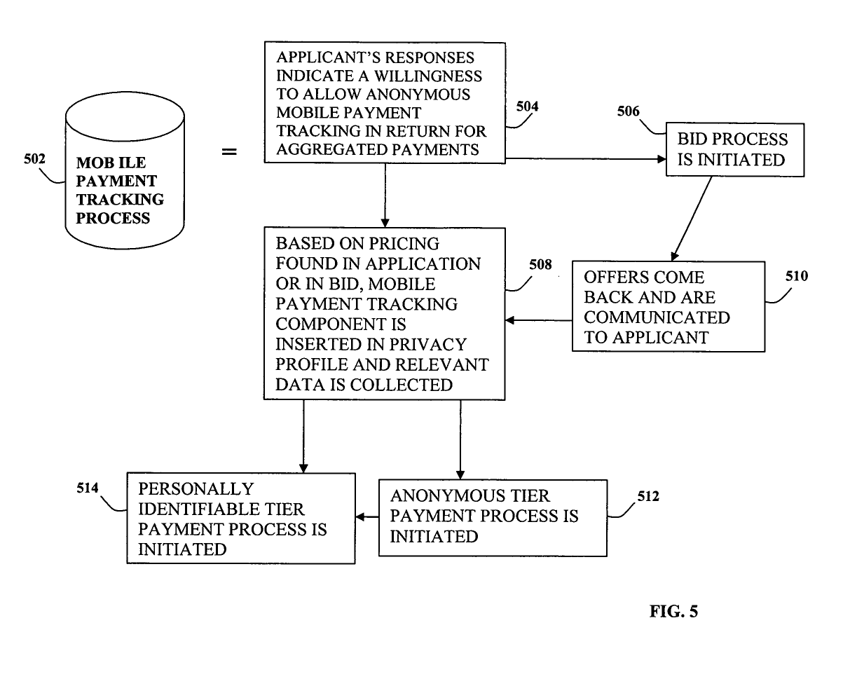

The mobile payment tracking process 502 illustrated within FIG. 5 first requires that the applicant indicate a willingness to allow for mobile payment tracking in return for cash compensation 504. The pricing will be pre-determined 508 or will initiate the bid process 506. After the offers are communicated to the consumer 510 they become part of the consumer's privacy profile 508 and if complied with will allow for payment based on anonymous data being made available 512 or actual PII being provided 514. Consumers can always increase payments by changing privacy tier levels from anonymous to PII status.

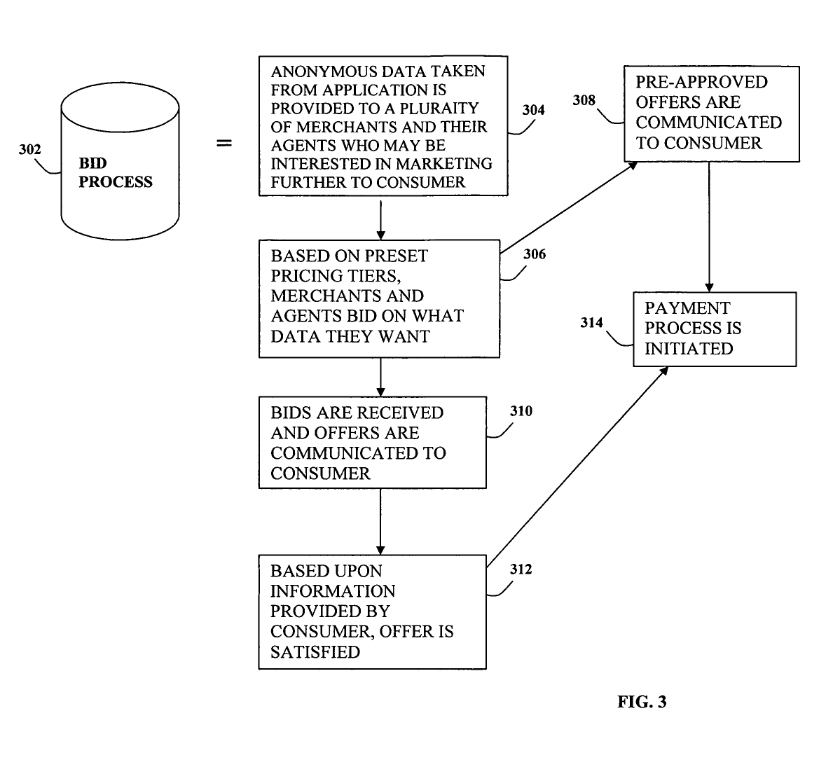

The bidding process 302 illustrated within FIG. 3 ensures that the widest range of offers are available to a consumer who submits to this cash-for-privacy process. The first tranche of data is provided on an anonymous basis and sent to potential buyers 304 who bid on the potential data 306 and create offers which are communicated to the consumer 310 and may be accepted 312. Upon acceptance of the bid offer or pre-approved offers 308, the payment process is initiated 314.

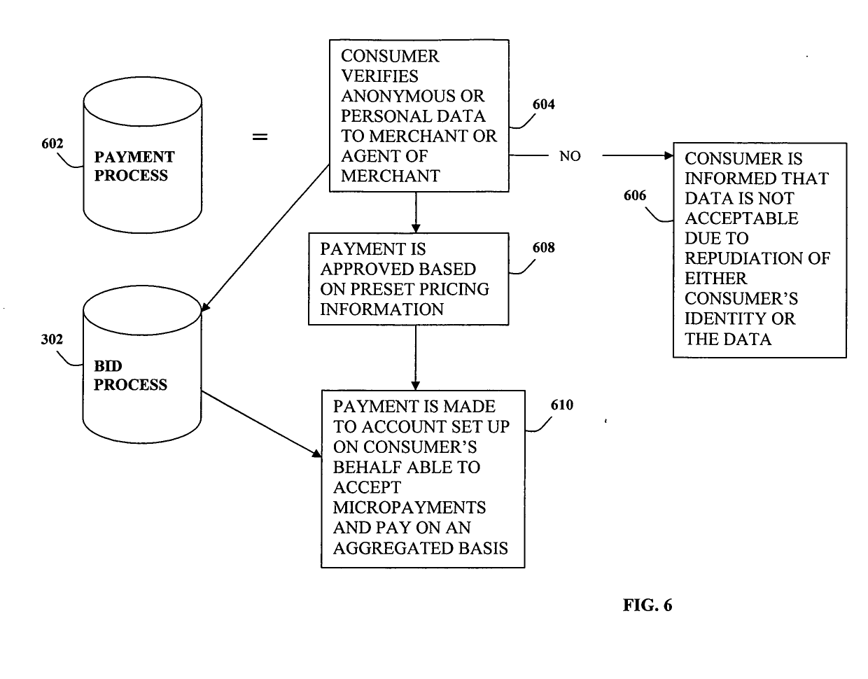

As illustrated in FIG. 6, the payment process 602 first requires that the consumer verify data provided 604 given such data may not be acceptable due to the repudiation of either the consumer's identity or the data 606. A payment may be approved based on preset pricing information 608 or may be sent out to the bid process 302 prior to a micropayment being made to the consumer 610.

In the preferred embodiment of the present invention, the privacy data exchanged between consumer and merchant/agent constantly changes on an incremental basis requiring that micropayments be aggregated and paid upon reaching a certain time or limit milestone.

In the preferred embodiment of the present invention, privacy data is tolkenized so that consumer data risk of loss is minimized. Also, consumer data is first released to merchants or agents on an anonymous basis before being released on a PII basis.

The preferred embodiment is implemented using hardware and software that can be written using multiple programming languages. The preferred embodiment can be used on a global computer network, on a personal computer, on a smartphone, on a portable communication device such as a tablet, or on any other hard-wired or wireless device that enables digitally stored information to be viewed and transmitted. Also, information displayed and viewed should be able to be printed, stored on or to other storage medium, and electronically mailed.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the present invention. Details of the structure may be varied substantially without departing from the spirit of the present invention and the exclusive use of all modifications, which come within the scope of the Claims to be filed, is hereby reserved.

What is claimed is:

1. A system for providing financial compensation in exchange for personal data, comprising the steps of:
receiving personal data from a consumer; and
processing at least one payment from a merchant to the consumer for the personal data.

2. The system according to claim 1, further comprising a steps of receiving a bid from a merchant to obtain the personal data.

3. The system according to claim 1, wherein an additional payment from the merchant is paid to the consumer for an additional item of personal data.

4. The system according to claim 1, wherein personal data is incrementally relinquished to the merchant in exchange for additional payments made to the consumer.

5. The system according to claim 1, wherein a certain item of personal data correlates to a set monetary amount.

6. The system according to claim 1, wherein different items of personal data correlate to a different monetary amount to be paid to the consumer by the merchant.

7. The system according to claim 1, wherein the payments are micropayments.

8. The system according to claim 1, wherein the merchant includes an agent of the merchant.

9. The system according to claim 1, wherein a consumer chooses to allow geo-tracking tracking in return for financial compensation.

10. The system according to claim 1, wherein a consumer chooses to allow mobile payment tracking in return for financial compensation.

11. The system according to claim 1, wherein the system is implemented on a mobile communications network.

12. The system according to claim 1, wherein the system is implemented on a computer network.

13. A system for consumers to obtain financial consideration for the incremental relinquishment of personal data, comprising the steps of:
responding to an application having personal data questions;
having merchants bid to obtain such data;
obtaining micropayments based on initial and future data responses;
obtaining micropayments in return for complying with offers received.

14. A method for determining compensation to the consumer who obtain financial consideration for the incremental relinquishment of personal data that minimizes the adverse tax implications for such cash payments, said method comprising the steps oh
determining potential taxes due for said payment if the payment were to be executed in a plurality of possible jurisdictions;
determining a plurality of taxable event scenarios, wherein each scenario is based on the applicability of various local, state, federal and non-US tax laws;
determining a suitable format for the payment, including rebates, to minimize the tax results; and
adding the monetary value of these steps, for each scenario, and to calculate said monetary sum of each said scenario,
wherein said cash payment is based on the adjusted sum and wherein this calculation is performed with a computing device.
